(19) United States
(12) Patent Application Publication
(10) Pub. No.: US 2006/0204803 A1
(43) Pub. Date: Sep. 14, 2006

(54) Fuel cell device, control method thereof, and electronic appliance using them

(75) Inventor: Atsushi Yamaguchi, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/179,483

(22) Filed: Jul. 13, 2005

(30) Foreign Application Priority Data
Mar. 10, 2005 (JP) 2005-067866

(51) Int. Cl. H01M 8/04

(52) U.S. Cl. 429/22; 429/34; 429/13

(57) ABSTRACT

The present invention relates to a fuel cell control of a fuel cell device using a liquid fuel, and simplifies its sensor configuration for obtaining control information. This is configured as a fuel cell device 2 using a liquid fuel m (diluted fuel M) comprising: a diluted fuel tank 20 for storing the diluted fuel to supply to a fuel cell 4; a fuel supply part 35 for supplying the fuel m in a fuel tank 30 to the diluted fuel tank; a water supply part 37 for supplying water w in a water tank 18 to the diluted fuel tank; a sensor (level sensor 42) for detecting a remaining amount level of the diluted fuel in the diluted fuel tank; and a control part 44 for controlling the diluted fuel in the diluted fuel tank to a reference level by operating either or both of the fuel supply part and the water supply part, based on the remaining amount level detected by the sensor.

### BACKGROUND OF THE INVENTION

1. Field of the Invention

The present invention relates to a fuel cell device using a high-concentration liquid fuel, and more specifically to a fuel cell device suitable for a power source of personal computers, mobile terminal devices, and the like, and to a control method thereof and an electronic appliance using them.

2. Description of the Related Art

A fuel cell is constructed such that a polyelectrolyte membrane is disposed as a proton-conducting or electron-conducting material; a fuel electrode is disposed on one side of the electrolyte membrane; and an oxidizer electrode is arranged opposite to the fuel electrode, wherein a liquid fuel such as a methanol aqueous solution including hydrogen component is supplied to the fuel electrode whereas air including oxygen component is supplied to the oxidizer electrode. The electrolyte membrane allows hydrogen protons in the liquid fuel at the fuel electrode side to pass through to couple to oxygen in the air at the oxidizer electrode side. Since electrons remaining in the hydrogen in the liquid fuel are extracted to outside as electricity by this coupling, this functions as a cell.

In such a fuel cell, when methanol is used as a liquid fuel, water (steam vapors) is generated at the oxidizer electrode side by the reaction of hydrogen and oxygen, and carbon dioxide (CO₂) is generated at the fuel electrode side by decomposition of methanol. In this processing, if electricity is generated through such an ideal chemical reaction wherein 1 mole of methanol and 1 mole of water are consumed at the fuel electrode whereas 1 mole of oxygen is consumed at the oxidizer electrode, then 3 moles of water are generated at the oxidizer electrode side and 1 mole of carbon dioxide is generated at the fuel electrode side.

In a fuel cell device comprising such a fuel cell, a fuel tank is provided for supplying a liquid fuel to the fuel cell. Although using high-concentration fuel can reduce the size of the fuel tank, a high performance is required for the electrolyte membrane. If the electrolyte membrane has a low performance, using high-concentration fuel increases the amount of fuel consumption and worsens the efficiency of electricity generation. Moreover, by using high-concentration fuel, there arises a possibility of shortening lives of component materials of the fuel cell, for example, the electrolyte membrane, catalyst materials such as platinum supported carbon, and adhesive materials to bond them. With all things considered, it is recommended to use fuel having about 1 mol concentration by keeping high-concentration fuel in the fuel tank and by diluting the fuel to about 1 mol concentration. In this case, diluting the high-concentration fuel requires water as a diluent and a diluted fuel tank to store the fuel diluted with water. Since driving the fuel cell consumes the fuel, a water level sensor monitors a water level of the diluted fuel tank as well as a concentration sensor monitors a concentration of the fuel, and based on them, replenishing volumes of water and fuel are controlled.

Among patent applications related to such fuel cell devices, there is one that includes an electrolyte membrane and uses a liquid fuel (e.g., Japanese Patent Application Laid-Open Publication No. 2003-297401 (paragraph No. 0021, FIG. 1, etc.)); one that includes a liquid level sensor in a fuel tank to judge whether or not a liquid level of the diluted fuel is within a predetermined range (e.g., Japanese Patent Application Laid-Open Publication No. 2004-265833 (paragraph No. 0035, FIGS. 1, 4, etc.)); one that is equipped with a configuration to adjust a liquid fuel concentration in its fuel cell device using a liquid fuel (e.g., Japanese Patent Application Laid-Open Publication No. 2004-127530 (paragraph No. 0022, FIG. 2, etc.)); and the like.

By the way, in the fuel cell device described in Patent Application Laid-Open Publication No. 2003-297401, in order to maintain to a predetermined concentration, fuel and water are supplied and then the fuel is diluted with the water through fuel concentration monitoring. In order to detect fuel depletion where no fuel exists when concentration does not rise in spite of fuel supply for a certain period of time, a concentration meter for monitoring concentration is required. In such a liquid fuel cell device, a concentration measurement of the liquid fuel in the liquid fuel tank is required, and a corrosion measure in order to protect the concentration meter is required as well.

Further, in the fuel cell described in Patent Application Laid-Open Publication No. 2004-265833, a sensor for detecting a fuel level in the diluted fuel tank is equipped, and performs detection and control by assuming a range of 15[%] to 90[%] of the capacity of the tank to be appropriate amount. In such detection and control, in order to set the appropriate range of 15[%] to 90[%] in its level detection, it is conceivable that a plurality of sensors corresponding to detection levels at two or more positions, or a sensor capable of detecting continuous level transition needs to be disposed. That is, in order to detect all the time that a liquid level of the fuel is within the appropriate range, disposition of a plurality of sensors such as multiple water level sensors or a water level area gauge that measures capacitance proportional to the contact area with the sensor is required. Moreover, with such a contact type sensor that touches the fuel directly, a measure for protecting from corrosion is required as well.

Furthermore, the fuel cell described in Patent Application Laid-Open Publication No. 2004-127530 discloses nothing but a configuration in which a liquid fuel is stored into a tank, and therefrom the liquid fuel is supplied to a fuel cell, wherein the liquid fuel to be supplied to the fuel cell adjusts its concentration in the tank.

In this way, although Patent Application Laid-Open Publication Nos. 2003-297401, 2004-265833, and 2004-127530 disclose level measurements of a liquid fuel and concentration monitoring or the like, they neither disclose at all such issues as to detection of concentration anomalies or fuel depletion and as to reduction of protective measures for sensors, nor disclose or suggest solutions for these issues. Furthermore, none of them discloses or implies inconveniences caused by the fuel remaining in the fuel cell after electricity generation is finished, nor discloses or suggests any measures.

### SUMMARY OF THE INVENTION

It is therefore an object of the present invention to simplify sensor configuration for obtaining control information, regarding fuel control of a fuel cell device using a liquid fuel.

The other object of the present invention is to detect fuel anomalies easily, regarding fuel control of a fuel cell device using a liquid fuel.

Another object of the present invention is to detect fuel depletion or concentration anomalies easily, regarding fuel control of a fuel cell device using a liquid fuel.

Yet another object of the present invention is to protect a fuel cell from the fuel remaining after electricity generation is finished, regarding fuel control of a fuel cell device using a liquid fuel.

Still another object of the present invention is to reduce protective measures for sensors.

Yet further object of the present invention is to provide electronic appliances using the above-described fuel cell device.

To attain the above-described objects, according to a first aspect of the present invention there is provided a fuel cell device using a liquid fuel, comprising a diluted fuel tank for storing a diluted fuel to supply to a fuel cell; a fuel supply part for supplying the fuel in a fuel tank to the diluted fuel tank; a water supply part for supplying water in a water tank to the diluted fuel tank; a sensor for detecting a remaining amount level of the diluted fuel in the diluted fuel tank; and a control part for controlling the diluted fuel in the diluted fuel tank to a reference level by operating either or both of the fuel supply part and the water supply part, based on the remaining amount level detected by the sensor.

According to such a configuration, the remaining amount level of the diluted fuel in the diluted fuel tank is detected by the sensor, and based on the detected level, either or both of the fuel and the water are supplied to the diluted fuel tank from the fuel supply part and the water supply part respectively. The fuel is diluted with the water, and thus a diluted fuel is produced in the diluted fuel tank. In this case, a fuel concentration of the diluted fuel is maintained constant by the supplied volume of the fuel and the water. The diluted fuel is supplied to the fuel cell from the diluted fuel tank for enabling continuous electricity generation. Here, only the detected level of the diluted fuel obtained from the sensor is used for fuel control. Thus, configuration of the sensor for obtaining control information necessary for the fuel control is simplified along with its protective measures.

To attain the above-described object, in this fuel cell device, the control part may be configured to judge as fuel anomalies in a case where the diluted fuel does not reach the reference level even if a predetermined time interval has passed after the sensor has detected a drop in the remaining amount level of the diluted fuel.

The diluted fuel in the diluted fuel tank varies its level through consumption of the fuel cell and the like. This remaining amount level is detected by the sensor and displayed as a detected level. Under the above-described control, the level of the diluted fuel is maintained to the reference level by the fuel and the water supplied to the diluted fuel tank based on the detected level. According to the above-described configuration, the sensor judges as fuel anomalies when the diluted fuel does not reach the reference level even if a predetermined time interval has passed after the sensor has detected a drop in the remaining amount level. At this time, the fuel anomalies may be attributed to fuel depletion from not reaching the reference level, or to fuel concentration anomalies and others caused by receiving only the water to compensate fuel shortages.

As to fuel concentration anomalies, judgment as concentration anomalies can be made in the case where the diluted fuel in the diluted fuel tank causes concentration anomalies due to excessive water supplied by continuous supplying operation of both the fuel supply part and the water supply part when fuel depletion occurs.

Furthermore, when a drop in the level of the diluted fuel is detected by the sensor, and then if supplying operation of both the water supply part and the fuel supply part is performed for a “predetermined time”, then the level of the diluted fuel tank is expected to reach the reference level only with the water supply, which needs to be avoided. This can be coped with by setting the “predetermined time” as a certain period of operation time necessary for the level of the diluted fuel tank to reach the reference level under normal operation of both the fuel supply part and the water supply part. In this way, judgment as fuel anomalies can be made if the detected level of the diluted fuel tank does not reach the reference level after this predetermined time interval has passed.

Furthermore, although there may be other anomalies than fuel depletion in some cases where the detected level of the diluted fuel tank does not reach the reference level, probably most cases are attributed to fuel depletion so that other anomalies need to be considered only in such cases where the level cannot be restored yet even after fuel refilling.

Furthermore, to attain the above-described objects, in this fuel cell device, the predetermined time interval may be a certain period of time after either the fuel supply part or the water supply part has been operated based on detection of below the predetermined level detected by the sensor.

Furthermore, to attain the above-described objects, in this fuel cell device, the sensor may be configured of a noncontact sensor that detects the remaining amount level of the diluted fuel in a noncontact manner.

Furthermore, to attain the above-described objects, in this fuel cell device, the control part may let the fuel supply part supply the fuel to the diluted fuel tank intermittently or continuously after judging the fuel anomaly, and wherein the control part may judge the fuel anomaly to be released if the reference level is detected by the sensor.

Furthermore, to attain the above-described objects, this fuel cell device may further comprise a fuel cell that generates electricity by the supply of the liquid fuel, wherein the liquid fuel remaining in the fuel cell is discharged from the fuel cell if electricity generation of the fuel cell is finished.

According to such a configuration, the liquid fuel remaining in the fuel cell is discharged when the electricity generation from the fuel cell is finished, so that the fuel cell not in operation can be protected from the liquid fuel and from deterioration. In order to discharge the liquid fuel from the fuel cell, for example, air purge by introducing air or suction of the liquid fuel from the fuel cell may be used.

Furthermore, to attain the above-described objects, this fuel cell device may further comprise a circulation path for circulating the liquid fuel in the liquid fuel tank to a fuel cell that generates electricity by the supply of the liquid fuel; a pump for transporting the liquid fuel to the fuel cell via the circulation path; and an air supply part for supplying the fuel cell with air to push the liquid fuel in the fuel cell toward the liquid fuel tank side via the pump if electricity generation of the fuel cell is finished.

According to such a configuration, during the electricity generation, the liquid fuel in the liquid fuel tank is circulated to the fuel cell via the circulation path and the pump. At that time, air supply from the air supply part is stopped. When the electricity generation is finished, the air supply part starts supplying the air and supplies the air for pushing the liquid fuel in the fuel cell toward the liquid fuel tank side to the fuel cell via the pump. As a result, the liquid fuel remaining in the fuel cell is flown toward the liquid fuel tank side by the air and then discharged from the fuel cell. Consequently, the fuel cell is filled with the air and thus protected from the liquid fuel.

Furthermore, to attain the above-described objects, in this fuel cell device, the air supply part may be comprised of a valve disposed in the circulation path, the valve switched over at the end of the electricity generation to flow the air into the fuel cell via the pump provided in the circulation path.

Furthermore, to attain the above-described objects, this fuel cell device may further comprise a circulation path for circulating the diluted fuel from the diluted fuel tank to the fuel cell, wherein on the diluted fuel tank, an exhaust outlet for the gas flowing in from the fuel cell via the circulation path is formed, and capacity of a space formed between the level position of the exhaust outlet and the level position representing the predetermined level is set to be equal to or less than the capacity of the fuel cell and the path extending from the fuel cell to the diluted fuel tank.

Furthermore, to attain the above-described objects, this fuel cell device may further comprise a concentration sensor for detecting a concentration of the diluted fuel in the diluted fuel tank, wherein depending on the concentration detected by the concentration sensor, the control part maintains the diluted fuel to a predetermined concentration by supplying the fuel from the fuel tank and by supplying the water from the water tank.

Furthermore, to attain the above-described objects, in this fuel cell device, the fuel cell is constructed in such a manner that an oxidizer electrode supplying air to one side of an electrolyte membrane and a fuel electrode supplying fuel to the other side of the electrolyte membrane are disposed sandwiching the electrolyte membrane.

Furthermore, to attain the above-described objects, this fuel cell device may further comprise a stabilization circuit for extracting electricity output from the fuel cell after stabilization; and a battery charged by receiving the output from the stabilization circuit.

To attain the above-described objects, according to a second aspect of the present invention there is provided a control method of a fuel cell device using a liquid fuel, comprising the steps of: storing a diluted fuel into a diluted fuel tank to supply to a fuel cell; supplying a fuel in a fuel tank to the diluted fuel tank; supplying water in a water tank to the diluted fuel tank; detecting a remaining amount level of the diluted fuel in the diluted fuel tank; controlling the diluted fuel to a reference level by supplying either or both of the fuel and the water, based on the remaining amount level of the diluted fuel in the diluted fuel tank; and judging as fuel anomalies in a case where the diluted fuel does not reach the reference level even if a predetermined time interval has passed after a drop in the remaining amount level has been detected.

According to such a configuration, by the same processing as described above, control of the diluted fuel in the diluted fuel tank as well as detection of fuel anomalies is performed, so that reliability of the fuel cell device can be enhanced.

Furthermore, to attain the above-described objects, in this control method of the fuel cell device, the predetermined time may be configured as a certain period of time after either or both of the fuel and the water are supplied based on detection of below the predetermined level.

Furthermore, to attain the above-described objects, this control method of the fuel cell device may further comprise the steps of supplying the fuel supply to the diluted fuel tank intermittently or continuously after the fuel anomaly is judged; and judging a release of the fuel anomaly if the reference level is detected.

Furthermore, to attain the above-described objects, this control method of the fuel cell device may further comprise the step of discharging the liquid fuel remaining in the fuel cell from the fuel cell if the fuel cell that generates electricity by the supply of the liquid fuel has finished electricity generation.

Furthermore, to attain the above-described objects, this control method of the fuel cell device may further comprise the steps of circulating the liquid fuel in the liquid fuel tank to the fuel cell via a circulation path; transporting the liquid fuel to the fuel cell by a pump via the circulation path; and discharging the liquid fuel from the fuel cell by supplying air to the fuel cell via the pump, if the electricity generation of the fuel cell is finished.

Furthermore, to attain the above-described objects, this control method of the fuel cell device may further comprise the steps of circulating the diluted fuel to the fuel cell from the diluted fuel tank via a circulation path; and returning the diluted fuel remaining in the fuel cell and the circulation path that extends from the fuel cell to the diluted fuel tank into a space formed between the level position of an exhaust outlet on the diluted fuel tank and the level position representing the predetermined level.

Furthermore, to attain the above-described objects, this control method of the fuel cell device may further comprise the steps of detecting a concentration of the diluted fuel in the diluted fuel tank; and maintaining the diluted fuel to a predetermined concentration by supplying the fuel from the fuel tank and by supplying the water from the water tank, depending on the detected concentration.

To attain the above-described objects, according to a third aspect of the present invention there is provided an electronic appliance comprising the above-described fuel cell device as its power source. According to such a configuration, since the electronic appliance is equipped with the fuel cell device that can recognize its fuel anomalies promptly and that can protect its fuel cell from remaining liquid fuel, reliability of the electronic appliance can be enhanced.

(1) According to the present invention, since the diluted fuel can be controlled to the reference level by supplying the fuel and the water to the diluted fuel tank based on a detected level of the diluted fuel, so that a stable fuel supply necessary for the fuel cell as well as simplification of its sensor structure can be achieved.

(2) According to the present invention, a drop in the remaining amount level of the diluted fuel in the diluted fuel tank is monitored, and when the detected level does not reach the reference level within a predetermined time interval, it is judged as fuel anomalies, so that structure of sensor for detecting fuel anomalies such as fuel depletion and concentration anomalies can be simplified and the fuel cell device with high reliability can be realized.

(3) According to the present invention, the fuel is discharged from the fuel cell when the electricity generation is finished, so that no fuel remains in the fuel cell out of operation, which eventually enables to protect the fuel cell, prevent degradation of the fuel cell by the remaining fuel, and extend life of the fuel cell.

(4) According to an electronic appliance on which the above-described fuel cell device is mounted, reliability as well as convenience of the electronic appliance can be enhanced.

Other objects, features and advantages of the present invention will become more apparent from the following detailed description of the embodiments with reference to the accompanying drawings.

### BRIEF DESCRIPTION OF THE DRAWINGS

FIG. 1 is a diagram showing a fuel cell device according to a first embodiment;

FIG. 2 is a diagram showing the outline of the fuel cell and its output part configuration;

FIG. 3 is a diagram showing a level sensor;

FIG. 4 is a flowchart showing control processing;

FIG. 5 is a flowchart showing fuel supply processing;

FIG. 6 is a flowchart showing the start of operation and continued operation of the fuel cell device;

FIG. 7 is a diagram showing a fuel cell device according to a second embodiment;

FIG. 8 is a block diagram showing a PC on which a fuel cell device according to a third embodiment is mounted;

FIG. 9 is a diagram showing a fuel cell device according to a fourth embodiment;

FIGS. 10(A), 10(B) are diagrams showing a valve structure;

FIG. 11 is a flowchart showing operation of the fuel cell device including air purge processing;

FIG. 12 is a diagram showing the air purge operation;

FIG. 13 is a diagram showing a fuel cell device according to a fifth embodiment;

FIG. 14 is a diagram showing the air purge operation;

FIG. 15 is a diagram showing a configuration example of a fuel cell device according to a sixth embodiment in which a water absorption part or the like is disposed on an exhaust pipe side of a water tank;

FIG. 16 is a diagram showing a combined fuel tank unit in which a liquid fuel tank is combined with a water absorption part;

FIG. 17 is an exploded perspective view showing a configuration of a PC according to a seventh embodiment;

FIG. 18 is a perspective view showing a configuration example of a combined fuel tank unit;

FIG. 19 is a front view showing a configuration example of a combined fuel tank unit;

FIG. 20 is a plan view showing a configuration example of a combined fuel tank unit;

FIG. 21 is a diagram showing a configuration example of a PDA according to an eighth embodiment;

FIG. 22 is a diagram showing a configuration example of a mobile phone according to a ninth embodiment;

FIG. 23 is a flowchart showing a processing example of an operation anomaly of a fuel cell device according to a tenth embodiment; and

FIG. 24 is a diagram showing a lighting fixture according to other embodiments.

### DETAILED DESCRIPTION OF THE PREFERRED EMBODIMENTS

### First Embodiment

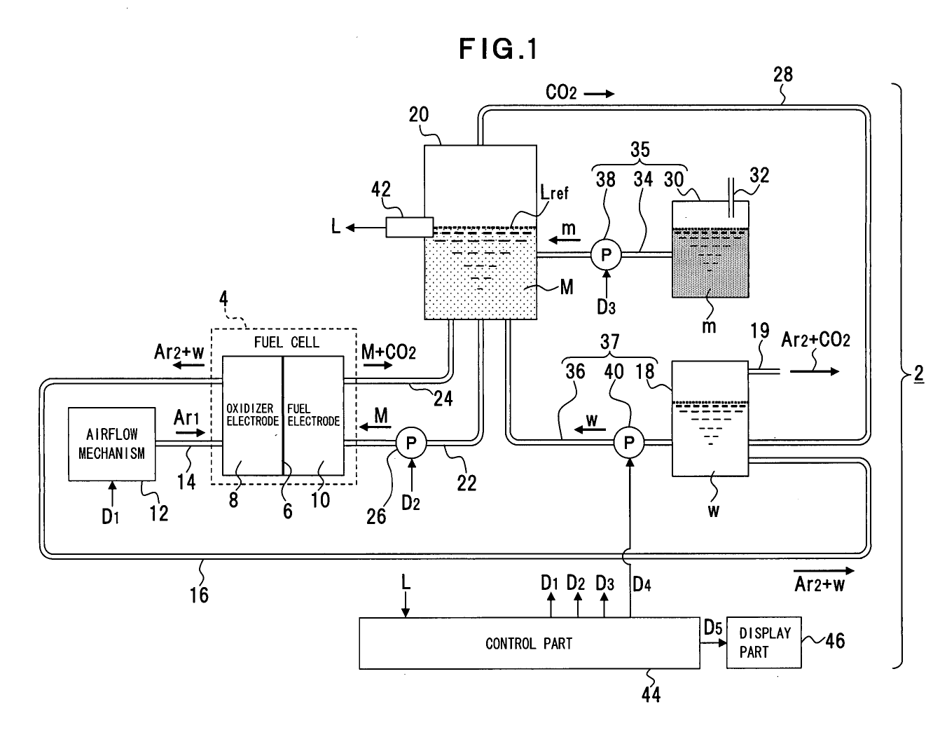

A first embodiment of the present invention will be described with reference to FIG. 1. FIG. 1 is a diagram showing a fuel cell device according to a first embodiment of the present invention.

This fuel cell device 2 includes a fuel cell 4 that generates electricity by using a fuel. In this fuel cell 4, an electrolyte membrane 6, an oxidizer electrode 8, and a fuel electrode 10 are disposed. The oxidizer electrode 8 and the fuel electrode 10 are disposed sandwiching the electrolyte membrane 6, and the oxidizer electrode 8 supplies air containing oxygen component to one surface of the electrolyte membrane 6, while the fuel electrode 10 supplies a liquid fuel containing hydrogen component, for example, methanol aqueous solution or the like to the other surface of the electrolyte membrane 6. The electrolyte membrane 6 is a permeable membrane formed by a proton-conductive or electron-conductive material, and is comprised of a polyelectrolyte membrane such as a proton-conductive solid polymer membrane composed of a perfluorsulfonic acid “Nafion” (registered tradename of Du Pont) or the like. Therefore, hydrogen protons in the liquid fuel at the fuel electrode 10 side pass through the electrolyte membrane 6, and these hydrogen protons are coupled to oxygen in the air supplied from the oxidizer electrode 8 side. As a result of this coupling, electrons remaining in the hydrogen in the liquid fuel are extracted to outside as electricity, and this electricity generation functions as a cell.

To the oxidizer electrode 8, an airflow mechanism 12 as an air supply part is attached via an air supply pipe 14, and an air Ar1 containing oxygen O₂ is supplied thereto by the drive of the airflow mechanism 12. The fuel cell 4 consumes oxygen by the reaction and yields water “w” that is the generated water by the reaction as steam vapors (hereinafter simply referenced as “water”). Since this water w has been vaporized so that it is discharged along with an excessive air Ar2 (i.e., exhaust air) from the oxidizer electrode 8 side. The excessive air Ar2 is mixed with carbon dioxide CO₂ resulting from the reaction. These excessive air Ar2 and water w are introduced into a water tank 18 via a recovery pipe 16 as a path, for example. An exhaust pipe 19 for discharging the excessive air Ar2 is provided on the water tank 18. In this embodiment, the excessive air Ar2 and the water w are introduced into below the surface of the water w in the water tank 18. The heat of the excessive air Ar2 is cooled down while passing through the recovery pipe 16, and during this cooling down process, it becomes condensed as the water w and recovered into the water tank 18. In this case, the water tank 18 serves as a water recovery tank in a sense that it recovers the water w, however, the water w that has been stored will be used as diluting water for the liquid fuel so that it also serves as a diluting water tank.

By the way, in this fuel cell 4, when methanol is used as a liquid fuel, water w (steam vapors) is generated at the oxidizer electrode 8 side by the reaction of hydrogen and oxygen via a proton catalyst of the electrolyte membrane 6, and carbon dioxide CO₂ is generated as bubbles at the fuel electrode 10 side by decomposition of methanol. For instance, if an electricity generation through such an ideal chemical reaction is performed wherein 1 mole of methanol and 1 mole of water are consumed at the fuel electrode 10 side whereas 1 mole of oxygen is consumed at the oxidizer electrode 8 side, then after the electricity generation, about 3 moles of water are generated at the oxidizer electrode 8 side and about 1 mole of carbon dioxide is generated at the fuel electrode 10 side. However, when methanol is used, although in theory equal moles of methanol and water may be consumed, in reality equal moles of consumption cannot occur, since there are extra fuel and water passing through the electrolyte membrane 6. Therefore, replenishing volumes of fuel and water need to meet the capacity of the fuel cell 4 in advance.

To the fuel electrode 10, a diluted fuel tank 20 is attached via an outgoing pipe 22 and a return pipe 24, and a circulation pump 26 is disposed in the outgoing pipe 22. A diluted fuel M stored in the diluted fuel tank 20 circulates by the drive of the circulation pump 26. From the fuel electrode 10, unreacted fuel M and carbon dioxide CO₂ flow into the diluted fuel tank 20 via the return pipe 24, thereby the unreacted fuel M is mixed in the diluted fuel M, whereas the carbon dioxide is separated from the unreacted fuel M and introduced into the water w in the water tank 18 from the diluted fuel tank 20 via the exhaust pipe 28 as a path, for example. In this case, even if the exhaust air Ar2 enters into the return pipe 24, the exhaust air is separated from the unreacted fuel M in the same way and introduced into the water tank 18 via the exhaust pipe 28.

To the diluted fuel tank 20, a liquid fuel tank 30 is connected via a fuel supply pipe 34 as well as the water tank 18 is connected via a water supply pipe 36. The fuel supply pipe 34 is provided with a fuel pump 38 and the water supply pipe 36 is provided with a water pump 40. That is, a fuel supply part 35 and a water supply part 37 are constructed. On the liquid fuel tank 30, an exhaust outlet 32 is formed, and for example, methanol is stored as the liquid fuel m. This liquid fuel m is supplied to the diluted fuel tank 20 by the drive of the fuel pump 38. And the water w in the water tank 18 is supplied to the diluted fuel tank 20 by the drive of the water pump 40. As a result, the diluted fuel M (=m+w) is produced.

In the diluted fuel tank 20, a level sensor 42 for detecting a remaining amount level of the diluted fuel M is disposed. In this embodiment, the level sensor 42 is a noncontact type sensor detecting a remaining amount level of the diluted fuel M without contacting the fuel, and the only sensor disposed in the diluted fuel tank 20. In this way, by simplifying disposition of sensors, protective measures such as protection of the level sensor 42 from corrosion by the diluted fuel M can be simplified.

The level sensor 42 detects a remaining amount level representing the remaining amount of the diluted fuel M, and issues a detection signal L. This detection signal L is added to a control part 44 as judging information such as operation anomalies and fuel anomalies, or as control information such as fuel control. The control part 44 consists of microprocessors and the like, which receives a detection signal L and then executes through its control programs various kinds of controls, such as an anomaly judgment of fuel anomalies or the like; generation of its display output; fuel supply control and airflow control to the fuel cell 4; level control of the diluted fuel M; and display of anomalies. The control part 44 issues driving signals D1, D2, D3, D4 and the like, whereby a fan motor at the airflow mechanism 12 is driven by the driving signal D1; the circulation pump 26 is driven by D2; the fuel pump 38 is driven by D3; and the water pump 40 is driven by D4. In addition, a display output D₅ obtained in this control part 44 is added to a display part 46. This display part 46 consists of an LED (Light Emitting Diode) or the like, and displays messages representing fuel anomalies such as fuel depletion, fuel supply anomalies, and fuel concentration anomalies.

In this embodiment, as described above, for example, one level sensor 42 for detecting a remaining amount level of the diluted fuel M is disposed in the diluted fuel tank 20, and monitors fuel status such as its level fluctuations. For instance, in the fuel cell 4 using methanol as fuel, methanol (fuel m) and water w are consumed in equal moles, so that if the fuel m and the water w corresponding to this consumption are supplied through monitoring of the remaining amount level of the diluted fuel M, then diluted fuel M of a certain fuel concentration can be produced and supplied to the fuel cell 4. In reality, there is the case in which equal moles are not consumed since there are extra fuel m and water w passing through the electrolyte membrane 6, however, this can be coped with by previously drawing a calibration curve representing the amount of the diluted fuel M consumed in the fuel cell 4 and by adjusting, based on the curve, replenishing volume of the fuel m and the water w to the capacity of the fuel cell 4.

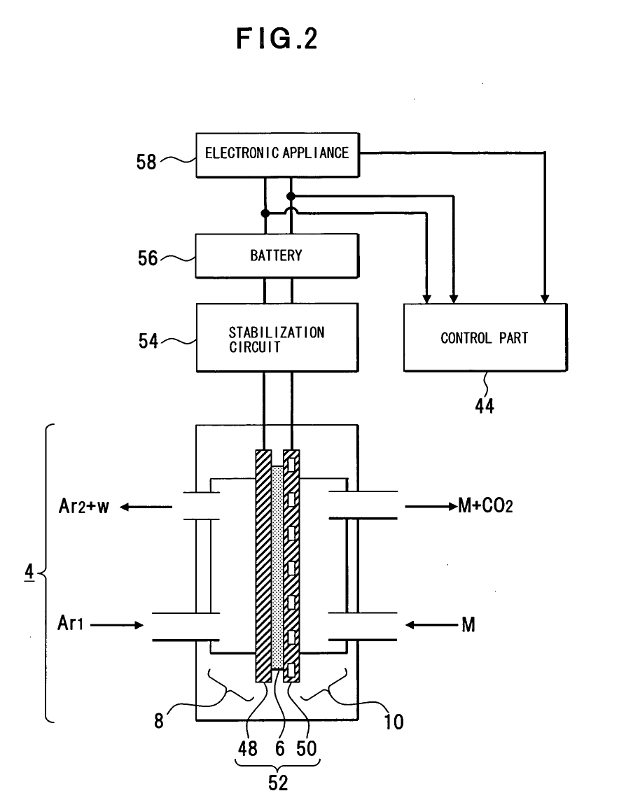

Next, a configuration of a fuel cell 4 and its output extraction will be described with reference to FIG. 2. FIG. 2 is a diagram showing the outline of the fuel cell 4 and its output part configuration. In FIG. 2, the same symbols are assigned to parts identical to those of the fuel cell device 2 shown in FIG. 1.

An oxidizer electrode 48 is disposed at the oxidizer electrode 8 and a fuel electrode 50 is disposed at the fuel electrode 10. The electrolyte membrane 6 is disposed sandwiching the oxidizer electrode 48 and the fuel electrode 50. In this fuel cell 4, a layered product formed of the electrolyte membrane 6 and the oxidizer electrode 48 and the fuel electrode 50 comprises an electrolyte plate 52.

Further, a battery 56, for example, is connected to the oxidizer electrode 48 and the fuel electrode 50 as a secondary cell via a stabilization circuit 54. The electricity generated at the oxide electrode 48 and the fuel electrode 50 is applied to the battery 56 after having been stabilized by the stabilization circuit 54, and the battery 56 is charged by the output of the fuel cell 4. The output of this battery 56 is applied to an electronic appliance 58 that comprises the fuel cell device 2 as its power source. This electronic appliance 58 may include, for example, a personal computer (PC), a mobile phone, or the like. Furthermore, terminal voltage of the battery 56 that feeds the electronic appliance 58 is added to the control part 44 as charging information representing a charging condition. In this case, operational information representing whether the electronic appliance 58 is in operation or out of operation is added to the control part 44.

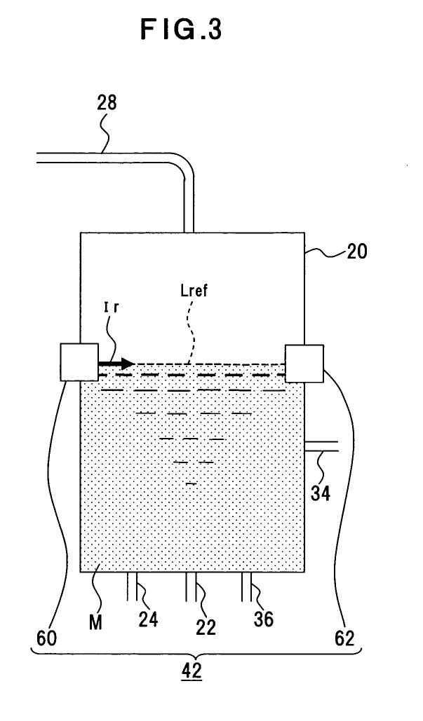

Next, a configuration example of the level sensor 42 will be described with reference to FIG. 3. FIG. 3 is a diagram showing the level sensor 42 comprised of a noncontact type sensor.

A reference level Lref is set as a predetermined level for the diluted fuel M in the diluted fuel tank 20, and a light-emitting part 60 is disposed in a position corresponding to this reference level Lref as well as a light-receiving part 62 for receiving infrared rays Ir emitted from this light-emitting part 60 is disposed. The level sensor 42 consists of both the light-emitting part 60 and the light-receiving part 62. In such a level sensor 42, when the diluted fuel M reaches the reference level Lref, the infrared rays Ir is cut off so that a detection signal L representing whether or not the diluted fuel M has reached the reference level Lref is obtained at the light-receiving part 62. That is, this detection signal L is level information of the diluted fuel M.

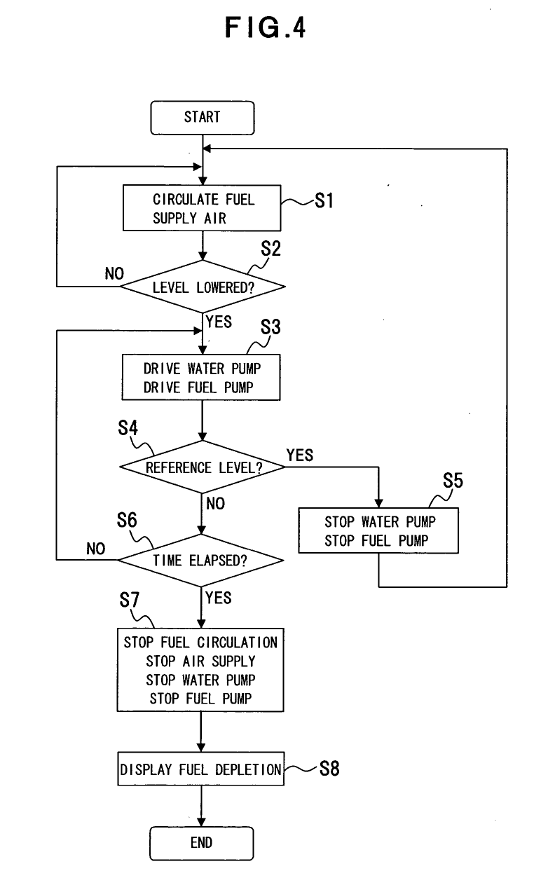

Next, operations of this fuel cell device 2 will be described with reference to FIG. 4. FIG. 4 is a flowchart showing control processing executed by the control part 44.

On receiving a driving order at the control part 44, the operation is started. That is, fuel circulation and air supply for the fuel cell 4 are executed (step S1). In the fuel circulation operation, the diluted fuel M is circulated from the diluted fuel tank 20 to the fuel electrode 10 by the drive of the circulation pump 26. In the air supply operation, the air Ar1 is supplied to the oxidizer electrode 8 by the drive of the airflow mechanism 12.

In operation state, a detection signal L of the diluted fuel M in the diluted fuel tank 20 is captured from the level sensor 42 into the control part 44, and a judgment is made whether or not its level is dropped (step S2). If the detected level is not down, capturing of detection levels is performed continuously or at a certain intervals. When the level of the diluted fuel M is down, the water pump 40 and the fuel pump 38 are driven, and the water w from the water supply part 37 and the liquid fuel m from the fuel supply part 35 are supplied to the diluted fuel tank 20 (step S3).

Through such operations at the water supply part 37 and the fuel supply part 35, it is judged whether or not the detected level of the level sensor 42 has reached the reference level Lref (step S4), and if the detected level has reached the reference level Lref, both the water pump 40 and the fuel pump 38 are stopped (step S5) and the processing returns to step S1. That is, when it is possible to recover to the reference level Lref through the operations of the water supply part 37 and the fuel supply part 35 after the level of the diluted fuel M is down, it is judged as a normal fuel control, and the electricity generation by the fuel cell 4 continues by repeating each step S1, S2, S3, S4, and S5.

However, if such a state continues for a certain period of time t in which the detected level of the diluted fuel M does not reach the reference level Lref in spite of the operations of the water supply part 37 and the fuel supply part 35 (step S6), in this embodiment, it is judged as fuel depletion and the operations of fuel circulation, air supply, water supply, and fuel supply are all stopped (step S7). As described above, the fuel circulation is stopped by a halt of the circulation pump 26; the air supply is stopped by a halt of the air supply mechanism 12; the water supply is stopped by a halt of the water pump 40; and the fuel supply is stopped by a halt of the fuel supply pump 38.

Here, assuming that Vm and Vw are transporting capacity per unit time of the fuel pump 38 and the water pump 40 respectively, these Vm and Vw are known from their rated values of the fuel pump 38 and the water pump 40, respectively. Then, assuming that these two pumps function normally, the following equations are obtained (Qm is the supplying volume of the liquid fuel m; Qw is the supplying volume of the water w; and t is a certain period of time in step S6):
Qm=Vm×t (1)
Qw=Vw×t (2)
Therefore, the entire supplying volume Qs (=Qm+Qw) to the diluted fuel tank 20 is as follows:
Qs=Qm+Qw=Vm×t+Vw×t=(Vm+Vw)t (3)
Assuming that the diluted fuel tank 20 has, for instance, an ideal cylindrical or rectangular shape, and that S is a horizontal cross-sectional area of its internal volume, then (dL/dt)n(=inclination) that is a level increment per unit time (dt) under normal operation becomes as follows:
(dL/dt)n=(Vm+Vw)/S (4)
When fuel depletion occurs in the liquid fuel tank 30, Vm becomes zero (Vm=0) or almost zero (Vm≈0). And in this case, (dL/dt) fw that is a level increment per unit time during fuel depletion becomes as follows:
(dL/dt)fw≈Vw/S<(dL/dt)n (5)

In this case, it is judged as fuel depletion and a message representing as such is displayed on the display part 46 (step S8) to inform fuel depletion. With this, users can recognize the fuel depletion and start supplying the fuel.

By the way, it causes excessive water in the diluted fuel M in the diluted fuel tank 20 to operate the water pump 40 and the fuel pump 38 continuously for a certain period of time t when a level lower than the reference level Lref is detected in step S4, since only the water w is supplied thereto. In this way, the diluted fuel M shows a concentration anomaly when fuel depletion occurs. Therefore, after a certain period of time t in step S6, either or both of fuel depletion and fuel concentration anomaly are judged as fuel anomalies, and the display in step S8 may display either or both of them.

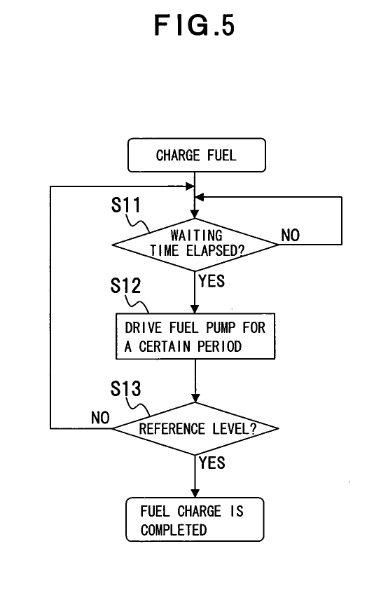

Next, fuel supply will be described with reference to FIG. 5. FIG. 5 is a flowchart showing fuel supply processing during fuel depletion.

If fuel depletion occurs, the processing waits for a predetermined waiting time tm (step S1), and during this waiting time tm, the diluted fuel m is charged into the diluted fuel tank 30. This waiting time tm is set as a necessary time for fuel charging. This fuel charging is performed by filling the liquid fuel m into the existing liquid fuel tank 30 or by replacing with the liquid fuel tank 30 filled with the liquid fuel m.

After a lapse of the waiting time tm, the fuel pump 38 is operated for a certain period of time tn (step S12), and the detection signal L from the level sensor 42 in the diluted fuel tank 20 is captured, and then a judgment is made whether or not the level has reached the reference level Lref (step S13). The reason why the fuel pump 38 is operated for a certain period of time tn is to help the diluted fuel m reach the diluted fuel tank 20, since air conceivably enters into the fuel supply pipe 34 due to fuel depletion. When this detected level does not reach the reference level Lref, steps S11, S12 continue further until the detected level reaches the reference level Lref, and then the fuel filling is completed. After this processing, the procedure moves on to electricity generation operation following step S1 (FIG. 4).

In this way, charging of the fuel m into the diluted fuel tank 20 is performed by operating the fuel pump 38 intermittently after fuel depletion is detected or judged, however, the fuel pump 38 may be operated continuously for a certain period of time.

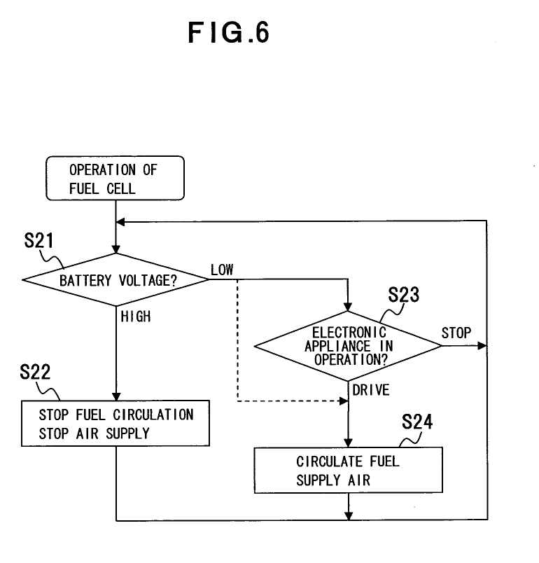

Next, start operation and continued operation of the fuel cell device 2 will be described with reference to FIG. 6. FIG. 6 is a flowchart showing the start operation and continued operation of the fuel cell device 2.

Electricity generation of the fuel cell 4 is started with fuel circulation and air supply. The control part 44 captures voltage information of the battery 56 from the fuel cell 4 and judges this voltage level (step S21) If the voltage of the battery 56 is high, then operations of fuel circulation and air supply are stopped (step S22). If the voltage is low, then a judgment is made whether or not the electronic appliance 58 being fed from the battery 56 is in operation (step S23). If the appliance 58 is not in operation, then the procedure returns to step S21 to monitor the voltage of the battery 56, while the electronic appliance 58 is in operation, then operations of fuel circulation and air supply are performed (step S24), thereafter the procedure returns to step S21. With these steps, the battery 56 is charged up to the reference voltage Vref.

According to such a configuration, when a driving order is received, the battery 56 is charged up to the predetermined voltage by the output of the fuel cell 4, and because the electronic appliance 58 in operation is fed from both the cell fuel 4 and the battery 58, its steady operation is secured. The battery 56 is not charged while the electronic appliance 58 is not in operation, since electricity generation is not performed. However, the battery 56 can be charged up to the reference voltage Vref, by configuring that step S23 is bypassed in order to charge the battery 56 when its voltage is low by operating the fuel cell 4, as shown with a broken arrow in FIG. 6. In addition, when driving is stopped, a message informing as such may be displayed on the display part 46.

### Second Embodiment

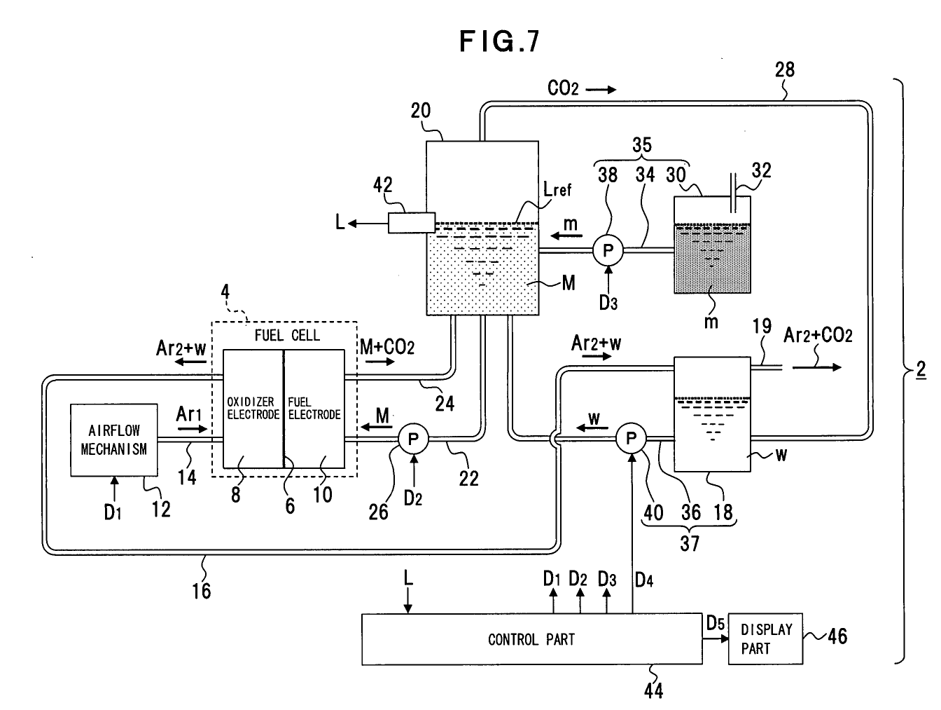

A second embodiment of the present invention will be described with reference to FIG. 7. FIG. 7 is a diagram of a fuel cell device according to a second embodiment. In FIG. 7, the same symbols are assigned to parts identical to those in FIG. 1.

In this embodiment, the excessive (exhaust) air Ar2 and the water w discharged from the oxidizer electrode 8 of the fuel cell 4 are introduced into above the water in the water tank 18 via a recovery pipe 16 in order to recover the water w and impurities contained in the air Ar2 into the water tank 18.

There exists a temperature difference between the oxidizer electrode 8 of the fuel cell 4 and the water w in the water tank 18, and in addition, heat absorption and heat radiation occur in the recovery pipe 16, so that liquefied portions vaporized in the air Ar2 are cooled down and condensed by the above-described temperature difference and the heat radiation, and recovered efficiently. As a result, to the air Ar2 passing through the water tank 18, gas-liquid separation is performed well and the air is discharged from the water tank 18 to the exhaust pipe 19 with its moisture removed. In this way, by introducing the air Ar2 and the water w into above the surface of the water in the water tank 18 via the recovery pipe 16, efficiency of recovering the water w is more enhanced and discharge of steam vapors from the exhaust pipe 19 is suppressed.

### Third Embodiment

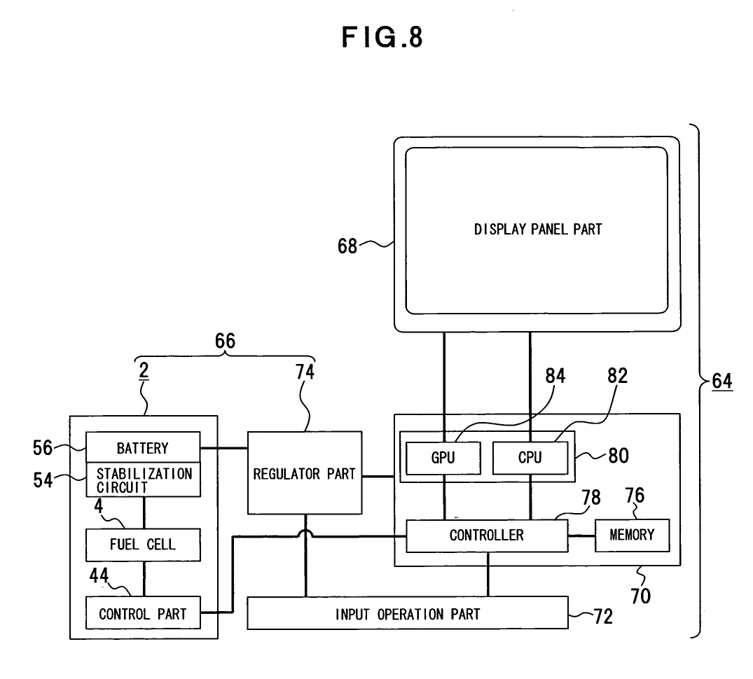

A third embodiment of the present invention will be described with reference to FIG. 8. FIG. 8 is a diagram showing a personal computer (PC) on which a fuel cell device 2 is mounted. In FIG. 8, the same symbols are assigned to parts identical to those of the first embodiment (FIGS. 1, 2).

In this embodiment, a PC 64 includes the fuel cell device 2 in its power source part 66. The fuel cell device 2, as described above, is equipped with the fuel cell 4, the control part 44, and others. The fuel cell device 2 of this embodiment is equipped with the stabilization circuit 54 and the battery 56 as a secondary battery. Furthermore, the PC 64 includes a display panel part 68, a circuit board 70, an input operation part 72, a regulator part 74, and others. The input operation part 72 consists of a mouse, a keyboard, and others. On the circuit board 70, various memories 76, a controller 78, a motherboard 80, and the like are mounted. On the motherboard 80, a CPU (Central Processing Unit) 82, a GPU (Graphic Processing Unit) 84, and the like are mounted. The display at the display panel part 68 is controlled by the GPU 84, and this display panel part 68 can also be used as the display part 46.

According to such a configuration, the electricity generated at the fuel cell 4 is added to the battery 56 after having been stabilized by the stabilization circuit 54, and the battery 56 is charged therewith. The output of this battery 56 is supplied to the circuit board 70, the input operation part 72, and the display panel part 68 after having been converted into a predetermined voltage by the regulator part 74.

In the PC 64 using such a fuel cell device 2 for its power source, its electricity supply continues for a long time by simply replacing such as fuel and water, instead of replacing batteries in conventional art, so that the PC 64 can be operated continuously and thus enhanced convenience can be provided.

In addition, display information such as the above-described fuel depletion and anomalies of fuel concentration in the fuel cell device 2 can be inputted from the control part 44 into the controller 78 of the PC 64 to display the above-described message on the display panel part 68. With this, users can recognize fuel depletion in the fuel cell device 2 and its operation status at the display on the display panel part 68.

### Fourth Embodiment

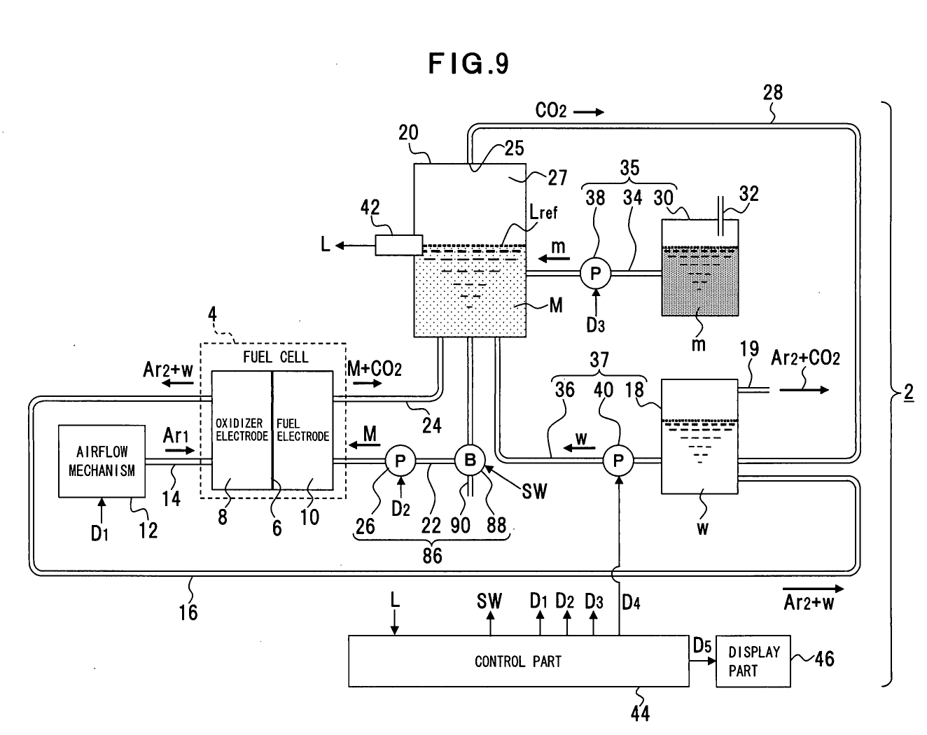

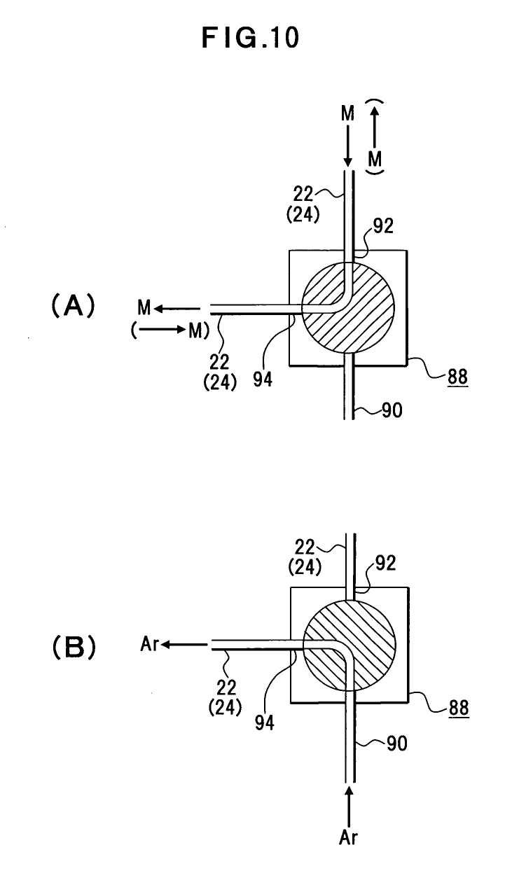

A fourth embodiment of the present invention will be described with reference to FIGS. 9, 10(A), 10(B). FIG. 9 is a diagram showing a fuel cell device according to a fourth embodiment, whereas FIGS. 10(A), 10(B) are diagrams showing channel switch of a valve. In FIG. 9, the same symbols are assigned to parts identical to those of FIG. 1.

A fuel cell device 2 of this embodiment includes an air supply part 86 disposed at the outdoing pipe 22 side for circulating the diluted fuel M, in order to discharge the diluted fuel M remaining at the fuel electrode 10 side in the fuel cell 4 when the electricity generation by the fuel cell 4 is finished. In this embodiment, a valve 88 is disposed, and a port 90 for taking in air Ar through this valve 88 is formed on the outgoing pipe 22. The circulation pump 26 is also used for the air supply part 86, and by switching the valve 88, the air Ar sucked from the port 90 into the outgoing pipe 22 is introduced into the diluted fuel tank 20 via the fuel electrode 10 side. That is, when the electricity generation of the fuel cell 4 is finished, the diluted fuel M remaining in the fuel electrode 10 is returned to the diluted fuel tank 20 with air purge from the fuel electrode 10 via the return pipe 24. With this configuration, the diluted fuel M does not remain in the fuel cell 4, and accordingly the fuel cell 4 can be protected from degradation caused by remaining fuel.

The valve 88, for example, is comprised of a three-way valve having three ports 90, 92, 94, as shown in FIG. 10(A), and during normal electricity generation, the channel between the ports 92 and 94 is open, with the port 90 closed. Because of this, the outgoing pipe 22 is shut from the outside air, and the diluted fuel M flows from the diluted fuel tank 20 into the fuel electrode 10 of the fuel cell 4, depending on operations of the circulation pump 26.

Furthermore, in air purge processing, as shown in FIG. 10(B), the channel between the ports 90 and 94 is open, letting the outgoing pipe 22 at the port 94 side open to the outside air. And the air Ar sucked into the port 90 by the operation of the circulation pump 26 flows into the fuel electrode 10 of the fuel cell 4 via the outgoing pipe 22. At this time, the port 92 is closed so that the outgoing pipe 22 at the diluted fuel tank 20 side is closed, and accordingly outflow of the diluted fuel M from the diluted fuel tank 20 is blocked. As a result, the contact of the fuel cell 4 with the diluted fuel M is blocked so that degradation of the fuel cell 4 while it is not operated can be prevented.

By the way, in the diluted fuel tank 20, a space 27 is formed between an exhaust outlet 25 and the reference level Lref, and the capacity of this space 27 corresponds to the volume of the diluted fuel M remaining partially in the fuel electrode 10, the outgoing pipe 22, and the return pipe 24, which is returned by the air purge. The capacity of the space 27 in the diluted fuel tank 20 can be controlled arbitrarily by a setting position of the reference level Lref. By enlarging this capacity, the above-described return volume of the diluted fuel M is stored into the diluted fuel tank 20, and thus overflow of the diluted fuel M from the diluted fuel tank 20 can be prevented. On the other hand, by setting the capacity of this space 27 a little less than the return volume of the diluted fuel M, the diluted fuel M flows out of the exhaust outlet 25 to the exhaust pipe 28 side, and thus fills the diluted fuel tank 20. With these, the diluted fuel M in the diluted fuel tank 20 is prevented from contacting with the outside air, and its respiration action is blocked as well, so that the diluted fuel M can be maintained constant to a certain concentration, and its degradation can be prevented.

Furthermore, the operation of the circulation pump 26 in the air purge processing is controlled by the control part 44, and display output representing the execution of this air purge operation is added to the display part 46 to display as such. If this display section 46 is comprised of the display panel part 68 of the PC 64 of the third embodiment, the display representing the execution of this air purge operation can be performed on the display panel part 68.

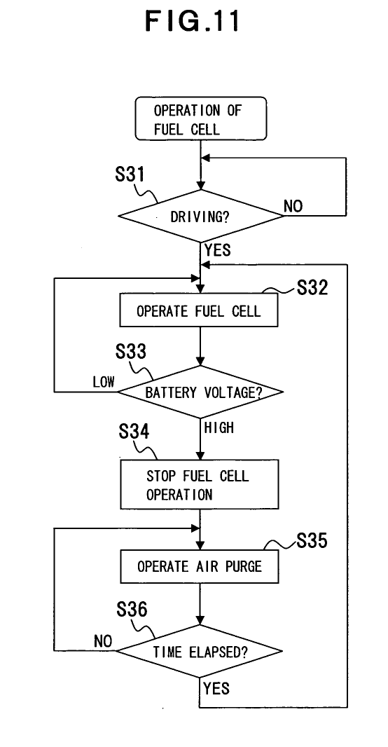

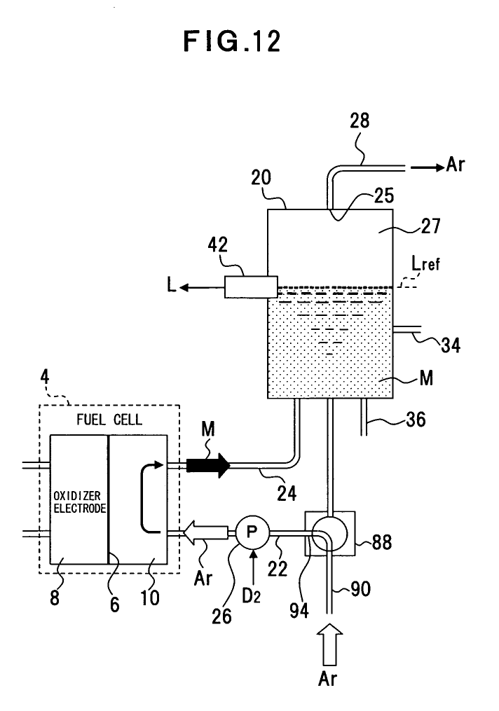

Next, operations of the fuel cell device 2 including the air purge processing will be described with reference to FIGS. 11, 12. FIG. 11 is a flowchart showing operations of the fuel cell device 2 including the air purge processing, and FIG. 12 is a diagram showing the air purge operation.

When the control part 44 receives a driving order, the operation is started (step S31); the fuel cell 4 is operated (step S32); and the battery 56 is charged. If voltage of the battery 56 is low, the fuel cell 4 is operated irrelevant to the drive of the electronic appliance 58. Voltage information is captured from the battery 56 into the control part 44, and the voltage level is judged (step S33). If the voltage of the battery 56 is high, operation of the fuel cell 4 is stopped (step S34).

When the operation of the fuel cell 4 is stopped, the procedure shifts to the air purge operation (step S35), and this air purge operation continues for a predetermined time interval ta (step S36), and then returns to step S31 after completing this air purge operation.

When the operation of the fuel cell 4 is stopped, the control part 44 is informed of its operation halt, and from the control part 44 a switching signal SW is added to the valve 88 as well as a driving signal D2 is added to the circulation pump 26. With this, the valve 88 is switched from the state in FIG. 10(A) to the state in FIG. 10(B), and the channel between the ports 90 and 94 is opened. As shown in FIG. 12, driving the circulation pump 26 in this state causes its transporting power to affect the port 90 side as suction power, and with this, the air Ar sucked from the port 90 is sent with pressure to the fuel electrode 10 side of the fuel cell 4 via the circulation pump 26 and the outgoing pipe 22, and to the diluted fuel tank 20 via the returning pipe 24. As a result, the diluted fuel M remaining in the outgoing pipe 22 at the downstream side of the circulation pump 26, in the fuel electrode 10 of the fuel cell 4, and in the returning pipe 24 are pushed back to the diluted fuel tank 20 by pressure of the air Ar. That is, with this air purge, the diluted fuel M is discharged from the fuel electrode 10, and thus the fuel electrode 10 is protected from degradation caused by remaining diluted fuel M.

In this case, the air Ar introduced into the diluted fuel tank 20 is introduced to the water tank 18 via the exhaust pipe 28, and then discharged to the outside air via the exhaust pipe 19, without remaining in the diluted fuel tank 20.

### Fifth Embodiment

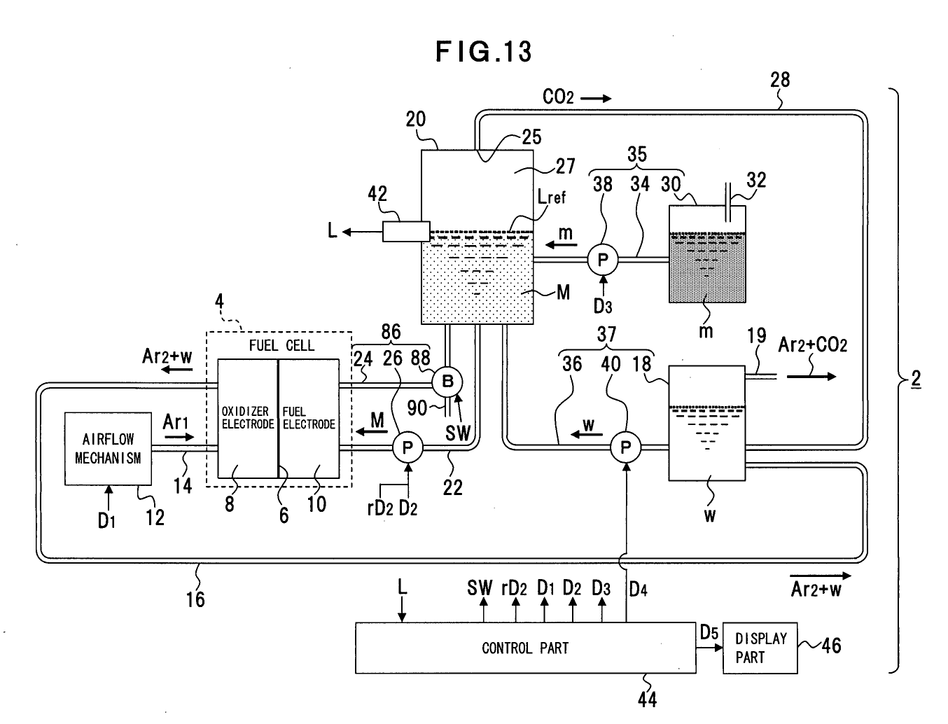

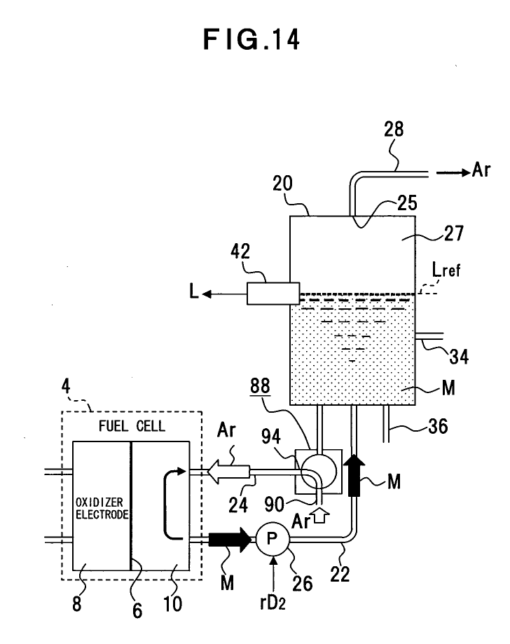

A fifth embodiment of the present invention will be described with reference to FIGS. 13, 14. FIG. 13 is a diagram showing a fuel cell device according to a fifth embodiment, and FIG. 14 is a diagram showing the air purge operation. In FIGS. 13, 14, the same symbols are assigned to parts identical to those of FIGS. 9, 10(A), 10(B), and 12.

In the fuel cell device 2 of this embodiment, the air supply part 86 is disposed at the return pipe 24 side for circulating the diluted fuel M in order to discharge the diluted fuel M remaining at the fuel electrode 10 side of the fuel cell 4 when electricity generation is finished. In this embodiment, the valve 88 is disposed at the return pipe 24 side, and the port 90 for taking in the air Ar via this valve 88 is formed on the return pipe 24. The circulation pump 26 is also used for the air supply part 86 to introduce the air Ar sucked from the port 90 into the return pipe 24 to the diluted fuel tank 20 via the outgoing pipe 22 at the fuel electrode 10 side, by switching the valve 88 as well as by operating the circulation pump 26 the other way around. In this case, for the circulation pump 26, for example, a pump that can switch its transporting direction by reversing a rotation direction may be used. Further, in this embodiment, the control part 44 is configured to obtain a reversal driving signal rD2 for reversing the circulation pump 26 in response to operation stop of the fuel cell 4.

The configuration and operation of the valve 88 is the same as the above-described diagrams shown in FIGS. 10(A), 10(B). That is, the valve 88 is comprised of a three-way valve having three ports 90, 92, 94, and during normal electricity generation, the channel between the ports 92 and 94 is opened, with the port 90 closed, as shown in FIG. 10(A). Further, in the air purge processing, the channel between the ports 90 and 94 is opened, as shown in FIG. 10(B).

When the operation of the fuel cell 4 is stopped, its operation halt is informed to the control part 44, and therefrom a switching signal SW is added to the valve 88 as well as the reverse driving signal rD2 is added to the circulation pump 26. In this case, the vale 88 is switched from the state of FIG. 10(A) to that of FIG. 10(B), and the channel between the ports 90 and 94 is opened. With this state, when the rotation direction of the circulation pump 26 is reversed, as shown in FIG. 14, transporting power of the circulation pump 26 functions as sucking power at the port 90 side, and with this power, the air Ar taken in from the port 90 is sucked into the fuel electrode 10 side of the fuel cell 4 via the return pipe 24 to reach the diluted fuel tank 20 via the outgoing pipe 22. As a result, the diluted fuel M remaining in the return pipe 24 at the upstream side to the circulation pump 26, in the fuel electrode 10 of the fuel cell 4, and in the outgoing pipe 22, is sucked and returned into the diluted fuel tank 20 by the air Ar that is sucked in and transported with pressure. That is, also with such an air purge, the diluted fuel M is discharged from the fuel electrode 10, and accordingly the fuel electrode 10 is protected from degradation caused by the remaining diluted fuel M.

In this case too, the air Ar introduced into the diluted fuel tank 20 is further introduced to the water tank 18 via the exhaust pipe 28, and then discharged to the outside air via the exhaust pipe 19, without remaining in the diluted fuel tank 20.

### Sixth Embodiment

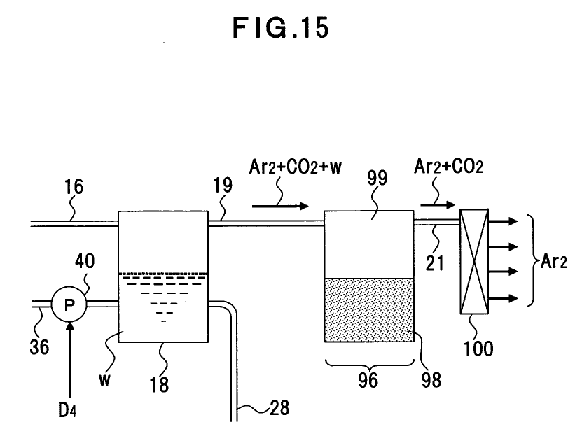

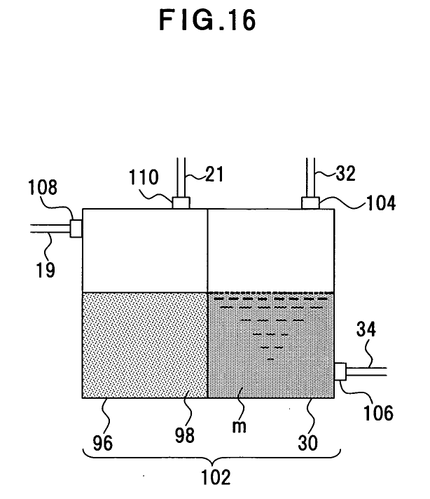

A sixth embodiment of the present invention will be described with reference to FIGS. 15, 16. FIG. 15 is a diagram showing a configuration example in which a water absorption part or the like is disposed at the exhaust pipe 19 side of the water tank 18, whereas FIG. 16 is a diagram showing a combined fuel tank unit in which the liquid fuel tank 30 is combined to the water absorption part. In FIGS. 15, 16, the same symbols are assigned to parts identical to those of the above-described embodiment (FIG. 7, etc.).

This fuel cell device 2 includes a water absorption part 96 disposed in the middle of the exhaust pipe 19 at the downstream side of the water tank 18. This water absorption part 96 is filled with a water-absorbing material 98, which dries the exhaust air Ar2 and carbon dioxide CO₂ by absorbing moisture in the exhaust air Ar2, the carbon dioxide, and uncollected water w, which are flown from the exhaust pipe 19 into the water absorption part 96. As the water-absorbing material 98, for example, silica gel or the like is used as a drying or moisture-absorbing agent. Silica gel is, as is known, a transparent glassy state solid where amorphous hydrated silica is partially dehydrated. Transportation of the carbon dioxide CO₂ and the uncollected water w to the water absorption part 96 is conducted by a pressure power of the air Ar1 sent from the above-described airflow mechanism 12.

In addition, in this embodiment, in the water absorption part 96, a reservoir space 99 is set where the water w flown out of the water tank 18 can be stored. This reservoir space 99 has enough capacity to store the water w overflowed from the water tank 18.

Moreover, in this embodiment, a filter part 100 is disposed at the downstream side of the water absorption part 96. This filter part 100 is connected to the water absorption part 96 via the exhaust pipe 21, and the exhaust air Ar2 is introduced thereto from the water absorption part 96. This filter part 100 consists of a gas-liquid separation membrane or the like for separating gas from liquid, and through this filter part 100, the exhaust air Ar2 and others are discharged to the outside air.

Most of the exhaust air Ar2, the carbon dioxide, and the water w, which have passed through the water tank 18 are recovered into the water tank 18, however, the exhaust air Ar2 and the carbon dioxide have yet to be dried up. Therefore, according to this configuration, the exhaust air Ar2 and the carbon dioxide having passed through the water tank 18 are introduced into the water absorption part 96 via the exhaust pipe 19, and moisture remaining in the exhaust air Ar2 and the carbon dioxide are absorbed thereat by the water-absorbing material 98, and then the exhaust air Ar2 and others are discharged to the outside air through the filter part 100. The water absorption part 96 can dry the exhaust air Ar2 and the carbon dioxide enough to turn into dry air. Furthermore, the filter part 100 consists of a gas-liquid separation membrane or the like, and it has a high capability of removing water droplets, although it cannot remove moisture absorbed in gas. Therefore, even if water droplets still remain in the exhaust air after having passed through the water absorption part 96, the filter can remove the water droplets. Consequently, even if the temperature of the exhaust air is higher than that of the outside air, dry air is discharged so that dew condensation can be significantly reduced.

Note that in this embodiment, the recovery pipe 16 is connected to the water tank 18 in such a way that the excessive (exhaust) air Ar2 is introduced into above the water w in the water tank 18, however, as shown in the first embodiment, the recovery pipe 16 may be connected to the water tank 18 in such a way that the excessive air Ar2 is introduced into inside the water w in the water tank 18.

In addition, the water absorption part 96 may be configured as a combined fuel tank unit 102, as shown in FIG. 16, by combining with the liquid fuel tank 30. Such a combined fuel tank unit 102 can be replaced as an integrated unit when the water absorption part 96 has lost its water-absorbing capability in response to consumption of the liquid fuel m.

Further, in this combined fuel tank unit 102, ports 104, 106 are formed on the liquid fuel tank 30 side; and ports 108, 110 are formed on the water absorption part 96 side. An exhaust pipe 32 is connected to the port 104, whereas a fuel supply pipe 34 is connected to the port 106. Furthermore, at the port 108 on the water absorption part 96, the exhaust pipe 19 is connected, whereas at the port 110, the exhaust pipe 21 is connected. With this configuration, the combined fuel tank unit 102 can be detachably replaced from the fuel cell device 2.

### Seventh Embodiment

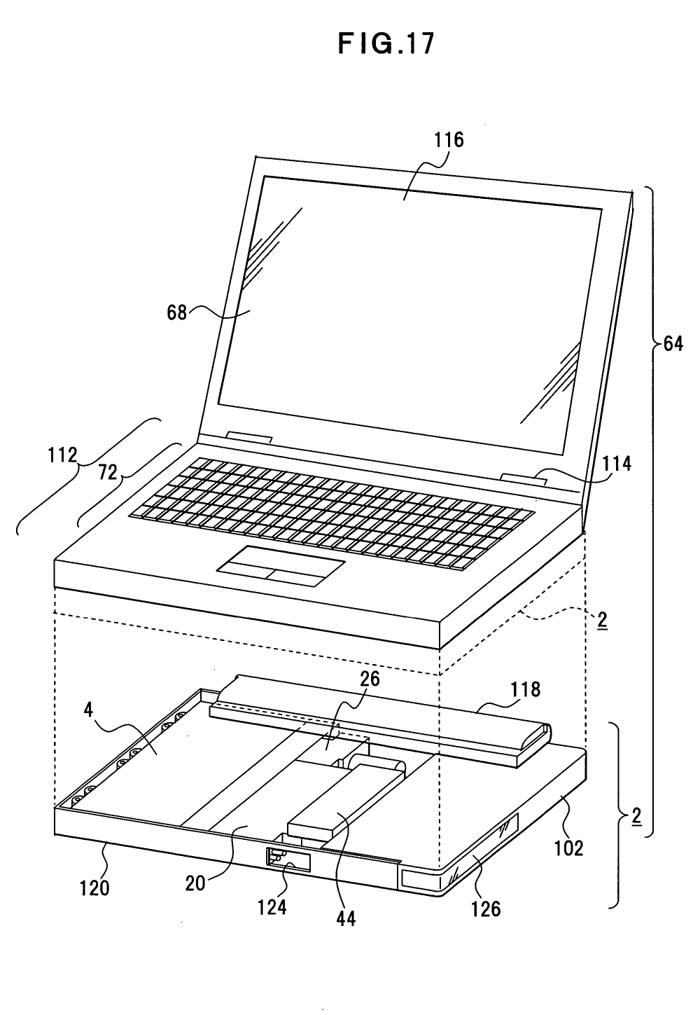

A seventh embodiment of the present invention will be described with reference to FIG. 17. FIG. 17 is an exploded perspective view showing a configuration of a PC 64 (FIG. 8) in which a fuel cell device 2 is mounted. In FIG. 17, the same symbols are assigned to parts identical to those of the above-described embodiments (FIGS. 1, 2, 8, and etc).

A PC 64 is an example of the electronic appliance in which the fuel cell device 2 is mounted, and in this embodiment, it is an example of a mobile personal computer. In this PC 64, a case part 112 and a display panel part 68 are connected to be openable/closable via a hinge part 114, and in the case part 112, an input operation part 72 including a plurality of keys and the like are disposed as well as the above-described circuit board 70 and the like are mounted. Moreover, in the display panel part 68, for example, an LCD (Liquid Crystal Display) 116 is disposed as a display part.

Further, on the rear part of the case part 112 of this PC 64, the fuel cell device 2 is mounted along with a battery pack 118. For instance, the battery pack 118 is embedded inside the case part 112, and the fuel cell device 2 is either fixed to integrate with the rear part of the case part 112 or attached thereto detachably. The battery pack 118 consists of a secondary cell such as the above-described battery 56 (FIG. 2), and charged by the fuel cell device 2.

The fuel cell device 2 includes a case part 120 corresponding to the case part 112 of the PC 64, and in this case part 120, the fuel cell 4, the airflow mechanism 12, the diluted fuel tank 20, the filter part 100, the combined fuel tank unit 102, and the like are mounted. There is a vent part 124 formed on the case part 120 to take in the outside air, and the vent part 124 is covered with a breathing waterproof sheet not shown.

There is a check window 126 formed on a side part of the combined fuel tank unit 102 of this embodiment in order to check a remaining amount of the fuel inside. This combined fuel tank unit 102 can be detached/attached separately from the case part 120. Accordingly, the remaining amount of the liquid fuel m can be checked easily from the check window 126, and the combined fuel tank unit 102 can be replaced easily.

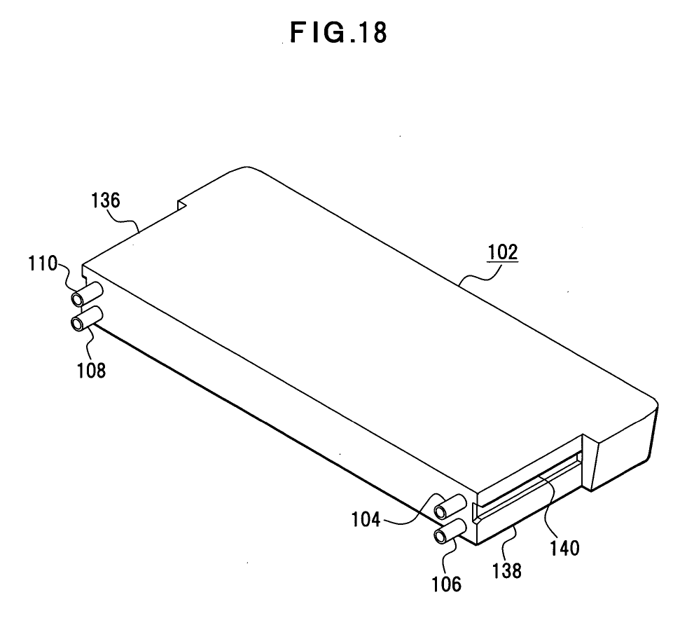

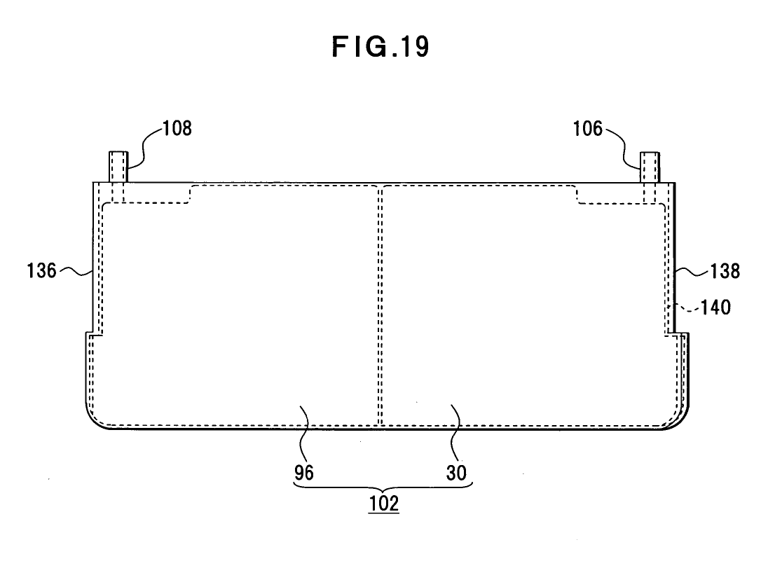

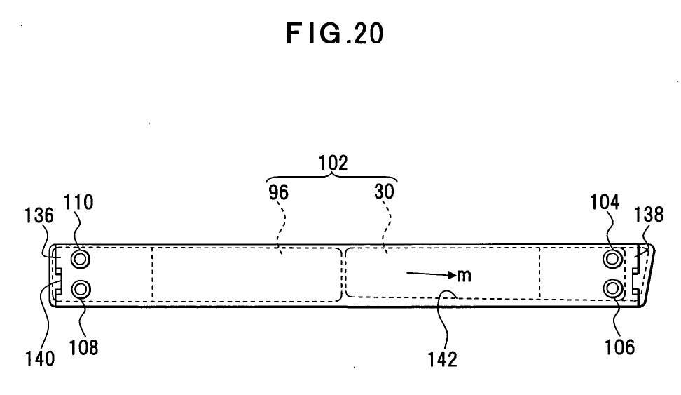

A configuration example of this combined fuel tank unit 102 will be described with reference to FIGS. 18, 19, and 20. FIG. 18 is a perspective view, FIG. 19 is a front view, and FIG. 20 is a plan view showing a configuration example of the combined tank unit 102.

As shown in FIG. 18, the combined fuel tank 102 is provided with side parts 136, 138 that are formed smaller than the depth of the case part 120, and on these side parts 136, 138, slide ditches 140 engaging the case part 120 side are formed. On the front part of this combined fuel tank unit 102, ports 104, 106, 108, 110 are formed. Subsequently, by conforming the slide ditches 140 to engage the case part 120 side, ports 104, 106, 108, 110 are respectively conformed and combined to the pipe path provided on the case part 120.

Also as shown in FIG. 20, comprising a bottom part 142 of the liquid fuel tank 30 with a lean surface tilted toward the port 106 side can make the liquid fuel m flow smoothly, can prevent residues in the tank, and accordingly can increase economy.

According to such a configuration, not only a configuration of the tank can be simplified compared with when the water absorption part 96 is disposed separately, but also level of convenience of the fuel cell device 2 is improved, since replacement is completed simply by replacing the combined fuel tank unit 102, without replacing or supplying the water-absorbing material 98 separately.

According to the PC 64 in which the above-described fuel cell device 2 is mounted, since operations such as replacing rechargeable batteries can be saved and a stable power supply for many hours can be obtained from the fuel cell device 2 by simply replacing the fuel, so that continuous operations is realized and convenience and mobility especially for a mobile PC are further increased.

### Eighth Embodiment

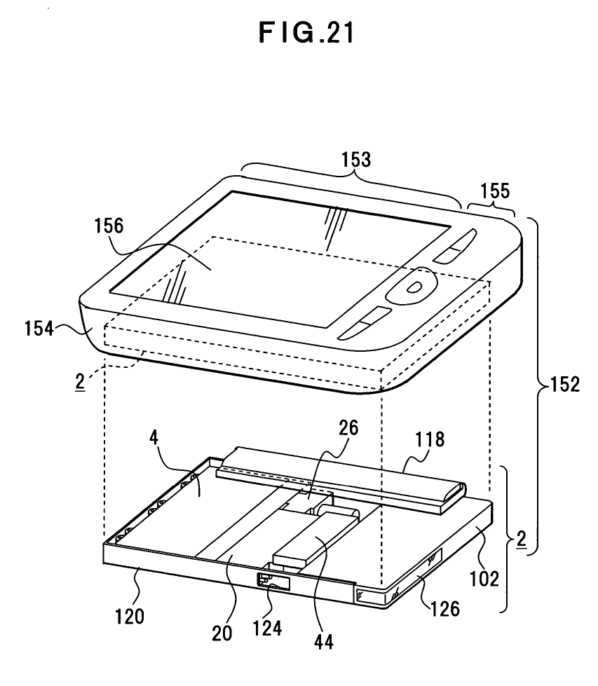

An eighth embodiment of the present invention will be described with reference to FIG. 21. FIG. 21 is a diagram showing a configuration example of a mobile information terminal called PDA (Personal Digital Assistant) on which a fuel cell device 2 is mounted. In FIG. 21, the same symbols are assigned to parts identical to those of the above-described embodiments (FIG. 17, etc.).

A PDA 152 is an example of the electronic appliance on which the fuel cell device 2 is mounted. In this PDA 152, a display panel part 153 and an input operation part 155 including a plurality of keys or the like are disposed on a case part 154 as well as the above-described circuit board 70 and others. Moreover, an LCD 156, for example, is disposed as a display part on the display panel part 153. On the rear part of this PDA 152, the fuel cell device 2 corresponding to the case part 154 is disposed. The configuration of the fuel cell device 2 is the same as described above.

In this manner, according to the PDA 152 on which the fuel cell device 2 is mounted, since operations such as replacing rechargeable batteries can be saved and a stable power supply for many hours can be obtained from the fuel cell device 2 by simply replacing the fuel, so that continuous operations is ensured, and convenience and mobility is further increased.

### Ninth Embodiment

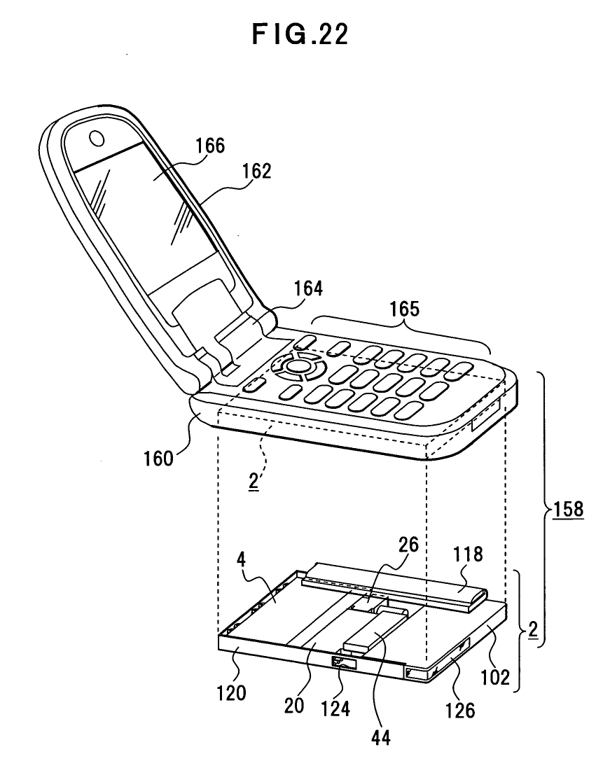

A ninth embodiment of the present invention will be described with reference to FIG. 22. FIG. 22 is a diagram showing a configuration example of a mobile phone on which the fuel cell device 2 is mounted. In FIG. 22, the same symbols are assigned to parts identical to those of the above-described embodiment (FIG. 17).

As a wireless communication device or a mobile terminal, a mobile phone 158, for example, is an example of the electronic appliance on which the fuel cell device 2 is mounted. In this mobile phone 158, a case part 160 and a case part 162 are connected to be openable/closable via a hinge part 164, and an input operation part 165 composed of a plurality of keys is disposed on the case part 160, and a display part, for example, an LCD 166 is disposed on the case part 162. The fuel cell device 2 is disposed on the rear part of this case part 160. The configuration of the fuel cell device 2 is the same as described above.

In this manner, according to the mobile phone 158 on which the fuel cell device 2 is mounted, since operations such as replacing rechargeable batteries can be saved and a stable power supply for many hours can be obtained from the fuel cell device 2 by simply replacing the fuel, so that continuous operations is ensured, and convenience and mobility is further increased.

### Tenth Embodiment

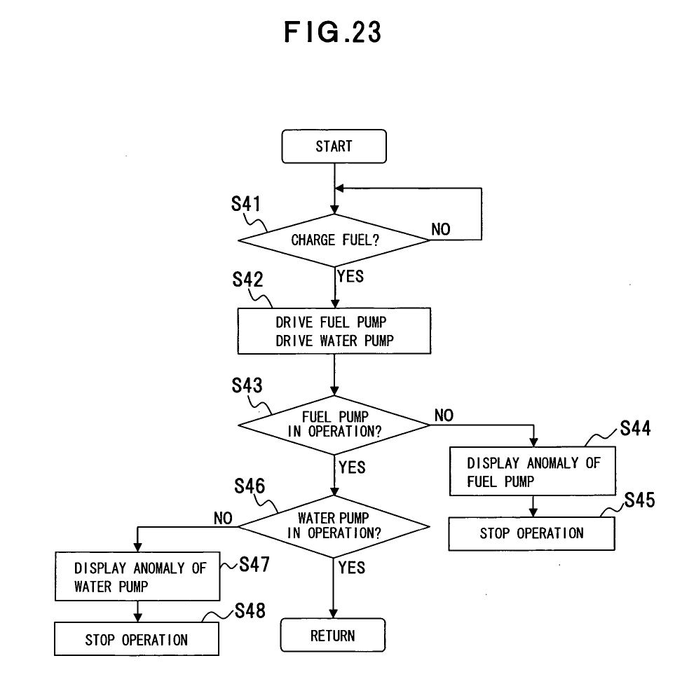

Next, one example of anomalous operation processing after fuel charge will be described with reference to FIG. 23. FIG. 23 is a flowchart showing a processing example of anomalous operation of the fuel supply part 35.

Following the display of fuel depletion, when the fuel is charged into the liquid fuel tank 30, or either the liquid fuel tank 30 or the combined fuel tank unit 102 is replaced (step S41), then a driving signal D₃ is added to the fuel pump 38 (FIG. 1) and a driving signal D₄ is added to the water pump 40 to drive these pumps (step S42). Thereat, it is judged whether or not the fuel pump 38 is in operation (step S43). The operation of this fuel pump 38 can be checked, for example, by detecting a motor current of the fuel pump 38.

When the fuel pump 38 is not in operation, it is judged as anomalies of the fuel pump 38 and displayed as such (step S44), and the operation of the fuel cell 4 is stopped (step S45).

Next, it is judged whether or not the water pump 40 is in operation (step S46). The operation of this water pump 40 can be checked, for example, by detecting a motor current of the water pump 40.

If the water pump 40 is not in operation, it is judged as anomalies of the water pump 40 and displayed as such (step S47), and if the fuel cell 4 is in operation, then its operation is stopped (step S48).

If the water pump 40 is in operation, it indicates normal operation so that the procedure returns to step S1 in FIG. 4 to drive the fuel cell 4.

By the way, in this judgment of anomalous operation (step S46), when an anomalous event occurs such as water depletion in the water tank 18 or clogging in the water supply pipe 36 of the water supply part 37, the transportation amount Vw becomes zero (Vw=0) or almost zero (Vw≈0), so that the level increment of the diluted fuel tank 20 per unit time, (dL/dt) w, becomes as follows;
(dL/dt)w≈Vm/S<(dL/dt)n (6)
Thus, by tracking the level increment, anomalies in the water supply part 37 can be found easily, and the anomaly is displayed on the display part 46. Further, if the water w exists in the water tank 18, it indicates anomalies either in the water pump 40 or in the water supply part 36 of the water supply part 37, and if there is no anomalies in the water pump 40, then there is anomalies in the water supply pipe 36.

### Other Embodiments

Next, other embodiments and their features and advantages will be described by listing hereinbelow.

(1) Although in the above-described embodiments, a PC, a PDA, and a mobile phone are exemplified as electronic appliances on which the fuel cell device 2 is mounted, other electronic appliances such as a camera and a radio may also be used. The same effects such as realizing stable operations for many hours can be expected by simply supplying-fuel without replacing rechargeable batteries or the like.

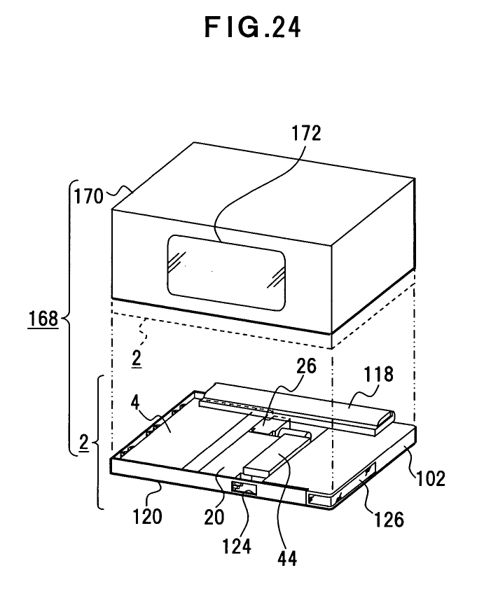

(2) As an electronic appliance on which the fuel cell device 2 is mounted, for example, as shown in FIG. 24, the fuel cell device 2 may be mounted to a main body 170 of a lighting fixture 168 such as a flashlight either to be detachable/attachable or integrally united. A 172 is a light-emitting part. According to this configuration, the same effects can be expected and level of convenience as an anti-disaster appliance can be increased.

(3) In the above-described embodiment, air purge (introduction of the air Ar) is performed as a processing for removing the diluted fuel M remaining in the fuel electrode 10 of the fuel cell 4, however, methods such as water purge (introduction of the water w into the fuel electrode 10 from the water tank 18 via the outgoing pipe 22 through the valve), and cleaning by the water w may also be used.

(4) In the above-described embodiment, as a measure for increasing the longevity of the fuel cell 4, the processing to fill the air Ar into the fuel cell 4 is performed after electricity generation is finished. In this processing, even if such events arise in which the diluted fuel M filled in the fuel cell 4 and in the pipes (outgoing pipe 22 and return pipe 24) overflows the diluted fuel tank 20 to be discharged into the water tank 18, the fuel cell 4 is still prevented from contacting the fuel, and since no respiration with the outside takes place, the diluted fuel M in the diluted fuel tank 20 can be maintained to a certain concentration at a certain level.

(5) The above-described embodiment uses the configuration in which the fuel m and the water w for diluting are stored in separate tanks and then mixed to produce the diluted fuel M to be stored into the diluted fuel tank 20 for consumption. However, other configurations may also be used in which the diluted fuel M of a certain concentration is filled into the diluted fuel tank 20 from the beginning, or in which the diluted fuel tank 20 filled with the diluted fuel M is unitized for replacement. In the same way, fuel anomalies may be judged to indicate such occasions as fuel charge or fuel replacement, based on the fuel level detection.

A most preferred embodiment and the like of the present invention have been described above. However, the present invention is not limited to the above description; it goes without saying that various modifications and alterations may be made by a person skilled in the art on the basis of the gist of the invention that is described in the claims and disclosed in the detailed description of the invention, and that such modifications and alterations are included in the scope of the present invention.

The present invention relates to a fuel cell device, and is useful such that it can judge fuel anomalies such as fuel depletion and fuel concentration anomalies by monitoring level transition in the diluted fuel tank, and that it can improve life of the fuel cell by removing the fuel remaining in the fuel cell.

The entire disclosure of Japanese Patent Application No. 2005-067866 including specification, claims, drawings and summary are incorporated herein by reference in its entirety.

What is claimed is:

1. A fuel cell device using a liquid fuel, comprising:
a diluted fuel tank storing a diluted fuel to supply to a fuel cell;
a fuel supply part supplying a fuel in a fuel tank to the diluted fuel tank;
a water supply part supplying water in a water tank to the diluted fuel tank;
a sensor detecting a remaining amount level of the diluted fuel in the diluted fuel tank; and
a control part controlling the diluted fuel in the diluted fuel tank to a reference level by operating either or both of the fuel supply part and the water supply part, based on the remaining amount level detected by the sensor.

2. The fuel cell device of claim 1, wherein the control part judges as fuel anomalies in a case where the diluted fuel does not reach the reference level even if a predetermined time interval has passed after the sensor has detected a drop in the remaining amount level of the diluted fuel.

3. The fuel cell device of claim 2, wherein the predetermined time interval is a certain period of time after either the fuel supply part or the water supply part has been operated based on detection of below the predetermined level detected by the sensor.

4. The fuel cell device of claim 1, wherein the sensor is configured of a noncontact sensor that detects the remaining amount level of the diluted fuel in a noncontact manner.

5. The fuel cell device of claim 2, wherein the control part makes the fuel supply part supply the fuel to the diluted fuel tank intermittently or continuously after judging the fuel anomaly, and wherein the control part judges the fuel anomaly to be released if the reference level is detected by the sensor.

6. The fuel cell device of claim 1, further comprising a fuel cell that generates electricity by the supply of the liquid fuel, wherein the liquid fuel remaining in the fuel cell is discharged from the fuel cell if electricity generation of the fuel cell is finished.

7. The fuel cell device of claim 1, further comprising:
a circulation path circulating the liquid fuel in the liquid fuel tank to a fuel cell that generates electricity by the supply of the liquid fuel;
a pump transporting the liquid fuel to the fuel cell via the circulation path; and
an air supply part supplying the fuel cell with air to push the liquid fuel in the fuel cell toward the liquid fuel tank side via the pump if electricity generation of the fuel cell is finished.

8. The fuel cell device of claim 7, wherein the air supply part is comprised of a valve disposed in the circulation path, the valve switched over at the end of the electricity generation to flow air into the fuel cell via the pump provided in the circulation path.

9. The fuel cell device of claim 1, further comprising:
a circulation path circulating the diluted fuel from the diluted fuel tank to the fuel cell, wherein on the diluted fuel tank, an exhaust outlet for the gas flowing in from the fuel cell via the circulation path is formed, and capacity of a space formed between the level position of the exhaust outlet and the level position representing the predetermined level is set to be equal to or less than the capacity of the fuel cell and the path extending from the fuel cell to the diluted fuel tank.

10. The fuel cell device of claim 9, further comprising
a concentration sensor detecting a concentration of the diluted fuel in the diluted fuel tank, wherein depending on the concentration detected by the concentration sensor, the control part maintains the diluted fuel to a predetermined concentration by supplying the fuel from the fuel tank and by supplying the water from the water tank.

11. The fuel cell device of claim 1, wherein the fuel cell is constructed in such a manner that an oxidizer electrode supplying air to one side of an electrolyte membrane and a fuel electrode supplying fuel to the other side of the electrolyte membrane are disposed sandwiching the electrolyte membrane.

12. The fuel cell device of claim 1, further comprising:
a stabilization circuit extracting electricity output from the fuel cell after stabilization; and
a battery charged by receiving the output from the stabilization circuit.

13. A control method of a fuel cell device using a liquid fuel, comprising the steps of:
storing a diluted fuel into a diluted fuel tank to supply to a fuel cell;
supplying a fuel in a fuel tank to the diluted fuel tank;
supplying water in a water tank to the diluted fuel tank;
detecting a remaining amount level of the diluted fuel in the diluted fuel tank;
controlling the diluted fuel to a reference level by supplying either or both of the fuel and the water, based on the remaining amount level of the diluted fuel in the diluted fuel tank; and
judging as fuel anomalies in a case where the diluted fuel does not reach the reference level even if a predetermined time interval has passed after a drop in the remaining amount level has been detected.

14. The control method of a fuel cell device of claim 13, wherein the predetermined time is a certain period of time after either or both of the fuel and the water are supplied based on detection of below the predetermined level.

15. The control method of a fuel cell device of claim 13, further comprising the steps of:
supplying the fuel to the diluted fuel tank intermittently or continuously after the fuel anomaly is judged; and
judging a release of the fuel anomaly if the reference level is detected.

16. The control method of a fuel cell device of claim 14, further comprising the step of discharging the liquid fuel remaining in the fuel cell from the fuel cell if the fuel cell that generates electricity by the supply of the liquid fuel has finished electricity generation.

17. The control method of a fuel cell device of claim 13, further comprising the steps of:
circulating the liquid fuel in the liquid fuel tank to the fuel cell via a circulation path;
transporting the liquid fuel to the fuel cell by a pump via the circulation path; and
discharging the liquid fuel from the fuel cell by supplying air to the fuel cell via the pump, if the electricity generation of the fuel cell is finished.

18. The control method of a fuel cell device of claim 13, further comprising the steps of:
circulating the diluted fuel to the fuel cell from the diluted fuel tank via a circulation path; and
returning the diluted fuel remaining in the fuel cell and the circulation path that extends from the fuel cell to the diluted fuel tank into a space formed between the level position of an exhaust outlet on the diluted fuel tank and the level position representing the predetermined level.

19. The control method of a fuel cell device of claim 13, further comprising the steps of:
detecting a concentration of the diluted fuel in the diluted fuel tank; and
maintaining the diluted fuel to a predetermined concentration by supplying the fuel from the fuel tank and by supplying the water from the water tank, depending on the detected concentration.

20. An electronic appliance on which a fuel cell device is mounted, wherein the fuel cell device comprises:
a diluted fuel tank storing a diluted fuel to supply to a fuel cell;
a fuel supply part supplying a fuel in a fuel tank to the diluted fuel tank;
a water supply part supplying water in a water tank to the diluted fuel tank;
a sensor detecting a remaining amount level of the diluted fuel in the diluted fuel tank; and
a control part controlling the diluted fuel in the diluted fuel tank to a reference level by operating either or both of the fuel supply part and the water supply part, based on the remaining amount level detected by the sensor.
